(19) United States
(12) Patent Application Publication
(10) Pub. No.: US 2013/0279060 A1
(43) Pub. Date: Oct. 24, 2013

(54) METHOD AND SYSTEM FOR SPATIALLY MODULATING MAGNETIC FIELDS USING CONTROLLABLE ELECTROMAGNETS

(71) Applicant: Thomas Wolfgang NEHL, Shelby Township, MI (US)

(72) Inventor: Thomas Wolfgang NEHL, Shelby Township, MI (US)

(73) Assignee: GM GLOBAL TECHNOLOGY OPERATIONS LLC, Detroit, MI (US)

(21) Appl. No.: 13/451,836

(22) Filed: Apr. 20, 2012

(51) Int. Cl. H01F 7/20

(52) U.S. Cl. 361/144; 361/143

(57) ABSTRACT

A method, device and system for spatially modulating magnetic fields using controllable electromagnets arranged into array configurations. An external controller modulates electromagnets and magnetic arrays by varying strength and polarity of electromagnets. Arrays are non-permanently latched and unlatched by controlling magnetic field patterns, without altering the properties of the magnetic elements, other than by electronic control signals. Arrays may contain combinations of electromagnets and permanent magnets.

### BACKGROUND OF THE INVENTION

Conventional magnetic array arrangements may use permanent magnets that may be arranged in a fixed pattern. Permanent magnet pole arrangements cannot be changed following magnetization. Arrays may be used two at a time, where two arrays may be moved such that each may be in a close proximity of the other, where such proximity may be determined by a range of a magnetic field. These two arrays may latch together in an orientation that may depend on magnetic patterns that may be permanently coded into permanent magnets that may comprise each array, where such orientation may be from a preferred pattern. Such a preferred latching orientation may be limited only to specific applications, such as fixturing. A latched orientation of these two arrays may be fixed, where it may difficult or impossible to alter. Methods of separating these arrays may be limited, and may involve physical movement of one array with respect to the other, such as by a rotational movement, and may require a simultaneous increase of a spatial separation. Other methods may be highly complex and may involve an internal heating element that may demagnetize a magnet, and such demagnetization may only occur once, as such may be permanent.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts an exemplary diagram illustrating a programmable magnetic array according to embodiments of the present invention;

FIG. 2 depicts an exemplary diagram illustrating a part of a programmable magnetic array according to embodiments of the present invention;

FIG. 3 depicts an exemplary diagram of a programmable magnetic array according to embodiments of the present invention;

FIG. 4 depicts an exemplary method according to embodiments of the present invention;

FIG. 5 depicts an exemplary method according to an embodiment of the present invention; and

FIG. 6 depicts an exemplary block diagram according to an embodiment of the present invention.

Embodiments of the invention are illustrated by way of example and not limitation in the figures of the accompanying drawings, in which like reference numerals indicate corresponding, analogous or similar elements, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

An embodiment of the present invention may provide a method and system for spatially modulated magnetic fields that may use controllable electromagnets. Some embodiments of the invention may be used in conjunction with various devices and systems. For example, electronic controls or control systems may be used to modulate one or more magnets within an array, or arrangement, of electromagnets. Although spatially modulated magnetic arrays may use permanent magnet poles that may be arranged in a fixed pattern, some embodiments may include one or more electromagnets within such a pattern that may allow for changing of, for example, pole arrangements. Embodiments of the invention may use electromagnets in place of one or both arrays of permanent magnets or permanent magnet poles, and may allow for changes, for example, in a coding. In some embodiments, electromagnets may be energized with a magnetic pole, for example, a North magnetic pole or a South magnetic pole. Such magnetic pole energizing may depend on various parameters, for example a desired coding pattern. In other embodiments of the invention, there may be provisions to reprogram one or more spatially modulated magnetic arrays.

According to an embodiment a programmable magnetic array may include two such arrays. Each programmable magnetic array may include n-electromagnets, where n is an integer, whose polarity may be individually controlled. A programmable magnetic array, or arrangement, may be comprised of magnets that may be electromagnets or a combination of permanent magnets and one or more electromagnets. Magnets may be arranged in a variety of patterns, for example an n×no grid, where n and m are integers, or any other pattern that may be suitable for an application or embodiment of the invention. Electromagnets within a programmable magnetic array may be individually controlled, controlled in groups or controlled simultaneously.

Magnetic poles, pieces of magnetic poles and/or a supporting structure may be fabricated using a variety of materials. Such materials may be magnetically soft; that is, capable of carrying magnetic flux and/or possessing soft magnetic properties. A combination of materials may also be used.

A second programmable magnetic array may be energized according to predetermined parameters or according to a particular fashion that may be predetermined, and may be used to align a second programmable magnetic array. Such a second programmable magnetic array may be comprised of permanent magnets, electromagnets, or a combination of permanent magnets and electromagnets. A first programmable magnetic array and a second programmable magnetic array may, in combination, be comprised of permanent magnets, electromagnets, or a combination of permanent magnets and electromagnets, and one or more electromagnets may be in at least one of these programmable magnetic arrays.

In some embodiments more than one programmable electromagnetic array may be used as a latching mechanism. For example, two programmable magnetic arrays may be used as a set such that together they may form a latching mechanism, and such a set may be nonexclusive to any two particular programmable magnetic arrays. An arrangement of such an embodiment may be such that a magnetic mechanism, such as one or more coils, may be de-energized following a programmable magnetic array alignment. A de-energizing of one or more electromagnets may allow for actuation of a latching mechanism.

Embodiments of the invention may be planar, or formed from planar structures. Other embodiments may be comprised of geometries other than planar, for example spherical, or combinations of geometries. Geometries of embodiments may include one or more elements of an embodiment, for example poles, coils, and/or coil leads. Differences in embodiments may be for a variety of reasons, for example due to packaging or other constraints.

Embodiments of the invention may include an array of programmable electromagnets, or controllable electromagnets, which may be programmed to provide a plurality of latching orientations. Latching may be with respect to a second programmable magnetic array, where a second programmable magnetic array may be comprised of permanent magnets, electromagnets or a combination of both. In either a first or second array, electromagnets and permanent magnets may be mixed within a single array. A first array may be paired with a second array, and latching may be facilitated from such pairing.

Programming of a magnetic array may be by a variety of means. For example an electrical controller may be used for programming a magnetic array. Such a controller may continuously program a magnetic array, or a magnetic array may be programmed by discrete selection of, for example, predetermined states. Such states may be determined dynamically, or may be stored in a memory. Such a memory may be operably connected to a controller. A controller may be operably connected to one or more programmable magnetic arrays. A controller may be operably connected to one or more electromagnetics, where such electromagnets may form at least part of a programmable magnetic array, or may be an individual electromagnet. A controller may be external to a programmable magnetic array.

A controller may provide controls, for example, electrical signals, to one or more electromagnets. Such signals may provide for actuating an electromagnet among operating conditions of an electromagnet. For example, an electromagnet may have a predetermined number of states, e.g. three, and such predetermined states may have unique designations, e.g. North pole, South pole and Off. A controller may vary an operating condition of an electromagnet continuously over a range of operating conditions, and such a range may be predetermined. For example, a range over which an operating state of an electromagnet may be continuously varied may be bounded by limits, e.g. North pole and South pole. A parameter of an electromagnet may be varied between such limits, for example a strength of an electromagnet. An example of a variation of a parameter of an electromagnet between limits may be a variation over a continuous range from a maximum strength North pole to a maximum strength South pole. Limits, e.g. a North pole or a South pole, may be of opposite magnetic polarities, or may be within a same magnetic polarity.

A programmable magnetic array may be a controllable magnetic array, and may be controlled by a controller. A controller may provide a variety of functions to a programmable magnetic array. A first programmable magnetic array may be paired with a second programmable magnetic array. Such a pair of programmable magnetic arrays may be in a variety of mutual states, e.g. locked or latched. A controller may be used to assist with changing a mutual state of two or more programmable magnetic arrays. For example, a controller may provide control, or control signals, that may assist with de-latching two programmable magnetic arrays, e.g. two locked programmable magnetic arrays.

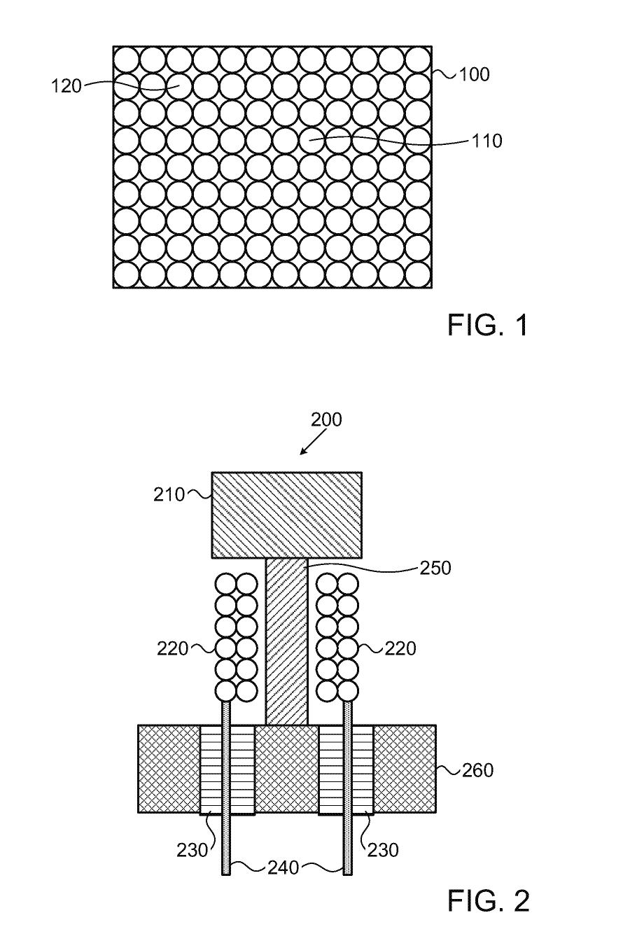

Reference is made to FIG. 1, which is an exemplary diagram illustrating a system of a programmable magnetic array according to an embodiment of the present invention. The system may include an array of magnets 100. Array 100 may be one of two arrays in an exemplary system, and may be comprised of programmable magnetic elements. Such magnetic elements formed into array 100, and paired with a second magnetic array may form a programmable magnetic array, or a programmable electromagnetic array. Array 100, or array 100 paired with a second array, may be firmed and connected to be able to generate spatially modulated magnetic fields. Each magnetic element 110 of such an array may be an electromagnet, undo electromagnets may form an array, where n is an integer. A polarity of each electromagnet element 110 may be controlled. Control of each electromagnet element 110 may be by a controller and each element 110 may be individually controlled. Each electromagnet element 110 may be programmable where a polarity of each pole may be programmable. A pole may be, for example, North or South. Array 100 may be partially comprised of permanent magnet element 120. Permanent magnet 120 may have a fixed polarity, and may be set to exhibit the characteristics of a fixed magnetic pole, for example North or South.

Embodiments of the invention may include a variety of arrangements of electromagnet elements 110, and may be formed into a grid, or any other suitable pattern. Permanent magnet elements 120 may be placed within such an arrangement, and may substitute for an electromagnet 110 in a particular position within such an arrangement, and a variety of positions and/or arrangements may be possible. In some embodiments, a plurality of permanent magnet elements 120 may be located within a programmable magnetic array. Permanent magnet elements 120 may be distributed within an array of programmable electromagnet elements 110 and may provide certain field profiles. A variety of designs and/or arrangements of permanent magnet elements 120 and electromagnet elements 110, and field profiles, may be formed, and all such arrangements and field profiles may be embodiments of the invention. In some embodiments, inclusion of permanent magnets may be a desirable feature, and may allow for electromagnets to be turned off. Electromagnet element 110 or permanent magnet element 120 may be a variety of sizes, and may be all of a consistent size within an array. Many sizes are possible, e.g. magnets may be sized in a millimeter range or may vary to much larger sizes.

Reference is made to FIG. 2, which is an exemplary diagram illustrating a part of a system of a programmable magnetic array according to an embodiment of the present invention. The system may include electromagnet 200. Magnetic surface 210 may be a magnetic pole when electromagnet 200 may be energized, for example North or South. Magnetic surface 210 may be a surface of any suitable shape, for example magnetic surface 210 may be planar or another geometrical shape. Core 250 may be metallic, for example ferrous or with magnetic properties, and may be physically or magnetically attached to magnetic surface 210. Core 250 may be positioned to be within coil 220, or within a magnetic field generated by coil 220 when coil 220 may be energized by an electrical current. An electrical conductor, e.g. wire, may be formed around an element, or core 250. Such a conductor may be formed into coil 220, where, for example, a wire may be formed into coil 220 around core 250 physically or magnetically connected to magnetic surface 210. Coil 220 may be comprised of any number, or fraction, of windings around core 250, and a number of windings may be correlated to a magnetic field strength that may be generated. Each end of coil 220 may be a terminal 240. Terminals 240 may be connected, physically or operably, to a controller, or controller circuit, controller computing device, etc. Supporting structure 260 may be used to shape array 100, and may support element 200 within array 100. Supporting structure 260 may provide for separation between elements 200, and a variety of shapes and/or dimensions of supporting structure 260 may be possible. Insulator 230 may separate terminal 240 from supporting structure 260. Insulator 230 may be formed from non-electrically conducting material, for example an insulator.

Electrical current may be provided each to and/or from terminals 240, and may be run through coil 220, which may be operably connected to terminals 240. Such an electrical current may operate to energize coil 220 and create a magnetic field that may flow through core 250. Core 250 may be physically or magnetically connected to magnetic surface 210, and magnetic surface 210 may become magnetically polarized, for example as a North magnetic pole or as a South magnetic pole. A direction of an electrical current flow through coil 220 may determine a magnetic polarity of magnetic surface 210, and such a direction may be controllable. A strength of an electrical current flow through coil 220 may determine a strength, or field strength, of a magnetic pole at magnetic surface 210. A direction and/or a strength of an electrical current flow through coil 220 may be determined by a controller. For example, a counter-clockwise current flow through coil 220 may provide, or induce, a North magnetic pole at magnetic surface 210, and a clockwise current flow through coil 220 may induce a South magnetic pole at magnetic surface 210. Electromagnet 200 may be an exemplary depiction of an electromagnet, and any other electromagnet may similarly be used by embodiments of the invention.

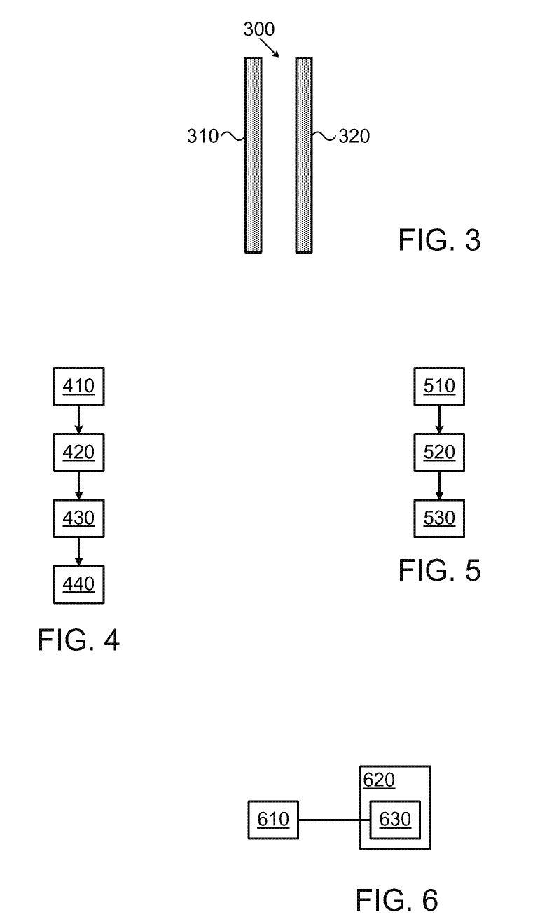

Reference is made to FIG. 3, which is an exemplary diagram of a programmable magnetic array according to an embodiment of the present invention. A programmable magnetic array 300 may be comprised of a first programmable magnetic array 310 and a second programmable magnetic array 320. Magnetic poles and/or a supporting structure of first programmable magnetic array 310 may be used to align second programmable magnetic array 320. Alignment may be magnetic alignment, and may be by magnetic field coupling or other suitable alignment methods. First programmable magnetic array 310 may be programmable magnetic array 100, or other similar programmable magnetic array, and may contain at least one or more electromagnetic elements 110 and/or one or more permanent magnet elements 120. Second programmable magnetic array 320 may be comprised of either all permanent magnet elements or a second electromagnetic array 100. Second array 320, when comprised of electromagnets, may be comprised of all electromagnets or a combination of electromagnets and permanent magnets. First programmable magnetic array 310 may be energized by a controller, and second programmable magnetic array 320 may be located to be within a magnetic field pattern generated by first array 310. Second programmable magnetic array 320 may be aligned, or programmed by first programmable magnetic array 310. First programmable magnetic array 310 and second programmable magnetic array 320 may generate spatially modulated magnetic fields. Electromagnetic elements 110 may be turned at alignment, and may be turned off at other times. In some embodiments, knowledge of a pole pattern of second programmable magnetic array 320 may be used to decide to turn on first programmable magnetic array 310. In other embodiments, first programmable magnetic array 310 and second programmable magnetic array 320 may be turned off, and such configuration may allow each to be attracted to each other. Embodiments may be such that first programmable magnetic array 310 may be controllable and second programmable magnetic array 320 may be programmed, or preprogrammed, with a magnetic pattern, or magnetic field pattern, and may be, for example, a typical pattern.

Reference is made to FIG. 4, which is an exemplary method of magnetic latching according to an embodiment of the present invention. A first programmable magnetic array 310 and second programmable magnetic array 320 may be used together as, for example, a latching mechanism. First programmable magnetic array 310 may be programmed 410 with a field pattern that may be formed by a physical arrangement of magnets within first programmable magnetic array 310 and/or by a controller. Second programmable magnetic array 320 may be located within a field pattern formed by first programmable magnetic array 310 to create a latch 420. Such a latch may align second programmable magnetic array 320. A control may be applied 430 that may allow for de-energizing of one or more coils, and may be applied following alignment of second programmable magnetic array 320. A latch may be removed 440 following such de-energizing. Latching may be created and/or removed by spatially modulated magnetic fields, and such fields may be generated by an array, for example a programmable magnetic array that may be programmed or controlled. Electromagnets may be used for applying and/or removing latches, and may be repeatedly applied and/or removed without permanently altering properties of either first programmable magnetic array 310 or second programmable magnetic array 320. In some embodiments latching may be used to prevent certain characteristics, for example, an undesirable build-up of heat, or increase in a temperature of such a programmable magnetic array system. Such a latching/unlatching method may be used for a variety of purposes, for example to break apart two parts that each may be connected to an array, or for mating to achieve an orientation which may then be fixed, or locked, into place. Such applications may prevent other movements, e.g. twisting, that may not be used in some applications.

Reference is made to FIG. 5, which is an exemplary method for creating a controllable magnetic field according to an embodiment of the present invention. A control signal may be applied 510 to a controllable electromagnet 200 within a programmable magnetic array 100, and may provide electrical current to coils. Coils may be energized 520 and create a magnetic field. A magnetic pole may be created 530 by directing a created magnetic field to a magnetic surface, and such magnetic poles may form a controllable magnetic array. Such a controllable magnetic array may generate one or more spatially modulated magnetic fields. Electromagnets may be used for applying and/or removing magnetic fields, and may be repeatedly applied and/or removed without permanently altering properties of either electromagnet 200 or array 100.

Reference is made to FIG. 6, which is an exemplary block diagram according to an embodiment of the present invention. Controller 610 may be a computing device, an electrical circuit, or any other device that may be suitable for providing control signals and/or electrical current to electromagnets, Controller 610 may provide variable or fixed electrical current and/or control signals that may operate to provide a fixed magnetic pole or a changeable magnetic pole of an electromagnet. A strength of a magnetic pole may be fixed or variable, and may depend on signals provided by controller 610. Controller 610 may include a processor, a memory, an interface device or any other component or electrical circuit that may be used for controller 610 to program magnetic array 620. Controller 610 may contain predetermined settings, e.g. factory settings that may be selectable from such a set. Controller 610 may be an external controller or an internal controller.

Controller 610 may be comprised of a computing device, and such a computing device may be operably connected to some or all magnets, or electromagnets. Controller 610 may change polarity by a variety of methods, for example by using electrical circuitry that may be constructed in a particular configuration, e.g. an “H” bridge. An “H” bridge may be connected such that each terminal 240 may be connected each to a switch, and each of, for example such two switches, may be connected to a source, e.g. a negative or positive terminal of a battery. Controller 610 may activate such switches and control a position of each switch. Controller 610 may actuate switches or other control mechanisms or electrical current control mechanisms at a variety of speeds, for example at a high speed or at a slow, or simpler, speed. Various speeds may be used, e.g. 0.1 millisecond to several milliseconds, or other ranges of times or fixed times. A variety of devices may be used for switching or control at a variety of speeds, for example particular devices may be chosen as such switches, e.g. metal oxide semiconductor field effect transistor (MOSFET) switches may be used, either individually, in sets, as arrays of switches or in other configurations. Controller 610 may also comprise control logic circuitry, a processor, memory and/or programming that may be used to implement control functions, for example switching.

Programmable magnetic array 620 may be any magnetic array that may contain at least one electromagnet 630, and may be, for example programmable magnetic array 100 or programmable magnetic array pair 300, or another programmable magnetic array arrangement, and may be programmed. Electromagnet 630 may receive control signals from controller 610, and may be programmed. Controller 610 may be connected to one or more electromagnets 630, and may provide a same control signal to all electromagnets or a different control signal to different electromagnets or sets of electromagnets.

A programmable magnetic array may not be limited to a planar structure, and many other structures may be possible. For example, designs of coils, poles, coil leads and/or terminals may differ for a variety of applications. Packaging or other constraints or limitations may allow for different combinations of coils, leads, magnetic poles and/or magnetic pole surfaces, and may result in a variety of geometrical shapes and topologies. All such combinations and permutations each may be an embodiment of the invention.

Other orientations of programmable magnetic arrays are possible. For example, a spherical actuator may be used, and polarity may be changed such that two surfaces may move with respect to each other. Another example may be two nested curves that may be used. In each orientation, a spatial alignment may not be required to be perfect, and tolerances and/or misalignments may be allowed, and an embodiment may function normally.

In some embodiments, a maximum distance may be established or predetermined. Many factors may contribute to determining a maximum distance, for example a diameter of a magnetic element, e.g. surface 210. A maximum distance may be determined by reference to a dimension, for example a dimension of an array element, e.g. 0.1 times a diameter of surface 210.

Embodiments of the invention including spatially modulated magnetic fields using controllable electromagnetics may have a variety of applications. For example, such embodiments may add continuous controllability to spatially modulated magnetic type structures for automotive applications. Such automotive applications may be during assembly or during use of any automotive product, service or device.

When used herein, magnetism and magnetic field may be interchangeable terms that describe the magnetic moment, or force, that an object or region exerts on another object or region. While magnetism may particularly describe the way that an object's subatomic particles are aligned, an object's magnetism may also describe the magnetic field emitted by the object. A magnetic field may be described by a vector field describing magnetic moment, and may include a direction and a magnitude (e.g., an intensity or strength). Magnetic field vectors or field lines may be emitted from a magnetic pole magnetic dipoles, monopoles). Regions of a material or object may be or may include magnetic dipoles. Magnetic dipoles may, for example, be positively and/or negatively magnetized regions (e.g., emitting magnetic fields) of varying magnitude or strength.

Magnetic fields may, for example, be generated using electromagnets, permanent magnets, ferromagnetic metals, spatially modulated magnetic field based devices, or other components or devices. A magnetic field may be spatially modulated, in that multiple adjacent magnetic fields (positive or negative) from an arrangement or array of magnetic sources create a close field of different magnetic polarizations and intensities. Spatially modulated magnetic fields may, for example, be created from an array of magnetic or electric field emission sources or magnetized regions in a material (e.g., a ferromagnetic metal). A magnet may, for example, be material or an object that emits or produces a magnetic field, which may be a vector field including a direction and a magnitude (e.g., an intensity or strength). A material (e.g., a ferromagnetic material, metal, or other type of material), object, or regions of a material or object may, for example, be positively, negatively, or neutrally magnetized, and may be referred to as having poles, e.g. a North pole and/or a South pole. Spatially modulated magnet fields may, for example, include a unique arrangement, combination or array of positively and negatively magnetized regions in a material. Such an array may be arranged horizontally on a flat object, flat portion of an object, a surface or other portion (such as a curved surface or an interior portion) of an object, or a plane. Each of multiple magnetized regions (e.g., magnetic regions, maxels, or other regions) may, for example, be a positively or negatively polarized magnetic field emission source of a pre-determined intensity. A magnetic region may be a region of varying size, surface area (e.g., 1 micron (μm) or greater in diameter), or volume. Multiple positive or negative magnetically charged regions may be arranged in an array or pattern on or in a material. An array or pattern of magnetized regions may, for example, create a unique magnetic pattern, fingerprint or signature. The array of magnetized regions may, for example, be pre-selected, programmed, or determined to have desirable properties (e.g., with other materials or objects with an array of magnetic regions or other magnetic materials).

A magnetic array may, for example, generate higher near-field magnetic flux than a typical magnet due to the fact that positively magnetized regions (e.g., positive poles) are located next to or in close proximity to negatively magnetized regions (e.g., negative poles). The close proximity of positively charged regions and negatively charged regions may result in reduced far-field magnetic flux and increase near-field magnetic flux because a shortest path or path of least resistance between oppositely polarized magnetized poles may be reduced. As a result of greater near-field magnetic flux, magnetic force (e.g., attractive or repulsive magnetic force) between one magnetic array and another ferromagnetic object, or between two complementary magnetic arrays, may be concentrated in the near-field and drop dramatically with distance. Using magnetic arrays may reduce the effects of far-field magnetism acting on other magnetic components within a device.

A magnetic array may include any suitable configuration, arrangement, or grouping of positively and negatively magnetized regions. A magnetic array may, for example, include adjacent positively magnetized regions and adjacent negatively magnetized regions. A magnetic array may be configured in a way that generates a higher near-field magnetic flux, or, in another example, directs the magnetic field towards a ferromagnetic object. An array or pattern of magnetized regions may, for example, create a unique or relatively unique magnetic pattern, fingerprint or signature. The array of magnetized regions may, for example, be pre-selected, programmed, or determined to have desirable properties (e.g., with other materials or objects with an array of magnetic regions or other magnetic materials).

Embodiments of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments of the invention may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for spatially modulating a magnetic field comprising:
applying a control signal to one or more coils of a controllable electromagnetic device;
energizing said coils using said control signal;
modulating a magnetic field from a surface magnetically coupled to said energized coil.

2. The method of claim 1, wherein said control signal is a variable signal.

3. The method of claim 1, wherein said electromagnetic device is further comprised of an array of at least one electromagnet, each comprised of a coil energized by said control signal.

4. The method of claim 3, wherein said electromagnetic device is further comprised of one or more permanent magnets.

5. The method of claim 1, further comprising removing said control signal from said electromagnetic device, where said removing returns said electromagnetic device to a same state as prior to application of said control signal.

6. A method for latching arrays comprising:
programming a first array, where said first array further comprises at least one programmable electromagnet;
pairing said first array with a second array, where said second array further comprises at least one magnet; and
latching said first array with said second array.

7. The method of claim 6, wherein said magnet within said second array is a permanent magnet or an electromagnet.

8. The method of claim 6, wherein said programming provides for a plurality of latching orientations among said first array and said second array.

9. The method of claim 6, wherein said programming is continuous.

10. The method of claim 6, wherein said programming is performed by an external controller.

11. The method of claim 6, further comprising applying a control to said latched pair of said first array and said second array, and removing said latch.

12. A programmable magnetic array device comprising:
a first magnetic array, comprising at least one programmable electromagnet; and
a second magnetic array, comprising at least one magnet, where said second array is paired with said first array.

13. The device of claim 12, wherein said magnet is a permanent magnet or an electromagnet.

14. The device of claim 12, wherein said first array is comprised of a plurality of programmable electromagnets and permanent magnets.

15. The device of claim 12, wherein said electromagnet is comprised of coils and magnetic material arranged to produce a magnetic pole, based at least on signals from a controller.

16. The device of claim 12, wherein said programmable electromagnet is continuously programmable.

17. A system for spatially modulating magnetic fields comprising:
a first array of a plurality of programmable electromagnets;
a second array of a plurality of magnets;
an external controller for providing control signals to said programmable electromagnets, wherein said control signals are used to spatially modulate the magnetic field generated by said first array, and the magnetic field generated by the pair created from among said first array and said second array.

18. The system of claim 17, wherein said control signals are used to latch or unlatch said first array and said second array, for a plurality of latching orientations.

19. The system of claim 17, wherein said control signals are discrete and selected from a predetermined set, or said control signals are continuous and vary among controlling said electromagnets from a maximum strength of a first magnetic pole to a maximum strength of a second magnetic pole, and further control the strength and polarity of said magnetic field of said first array.

20. The system of claim 17, wherein structures comprising said first array and said second array are each formed into one of a plurality of shapes, selected from a set of planar and non-planar shapes, and said shapes are determined by packaging or design.
